(19) United States
(12) Patent Application Publication
(10) Pub. No.: US 2026/0109643 A1
(43) Pub. Date: Apr. 23, 2026

(54) Precipitated Calcium Carbonate (PCC) as Feedstock in Hydraulic Cement Production, and Hydraulic Cements Produced Therefrom

(71) Applicant: Travertine Technologies, Inc., Boulder, CO (US)

(72) Inventor: Laura N. Lammers, Boulder, CO (US)

(21) Appl. No.: 19/117,364

(22) PCT Filed: Oct. 3, 2023
(86) PCT No.: PCT/US2023/034367

§ 371 Date: Mar. 31, 2025

Related U.S. Application Data
(60) Provisional application No. 63/415,168, filed on Oct. 11, 2022.
(60) Provisional application No. 63/443,217, filed on Feb. 3, 2023.

(51) Int. Cl. C04B 2/10; B01J 6/00; B01J 19/24; C04B 111/00

(52) U.S. Cl. CPC C04B 2/10; B01J 6/001; B01J 19/24; C04B 2111/00019

(57) ABSTRACT

Methods of making a hydraulic cement are provided. Aspects of the methods include employing precipitated calcium carbonate (PCC), such as a CO₂ sequestering PCC, as a feedstock for lime (CaO) production. Also provided are hydraulic cements and concretes produced by methods of embodiments of the invention, as well as products produced therefrom. In addition, systems for practicing methods of embodiments of the invention are provided.

### CROSS-REFERENCE TO RELATED APPLICATIONS

Pursuant to 35 U.S.C. § 119(e), this application claims priority to the filing dates of U.S. Provisional Application Ser. No. 63/415,168 filed on Oct. 11, 2022 and U.S. Provisional Application Ser. No. 63/443,217 filed on Feb. 3, 2023; the disclosures of which applications are herein incorporated by reference.

### INTRODUCTION

Anthropogenic release of carbon dioxide to the atmosphere is causing global warming and climate change, and the extreme weather effects of warming are already being keenly felt. Globally, anthropogenic CO₂ emissions exceed 40 Gt/year, and affordable solutions to permanently sequester carbon are actively being sought to prevent further catastrophic environmental damage. Direct air capture of CO₂ with durable storage (DACS) has been proposed to enable the drawdown of atmospheric CO₂ concentrations to pre-industrial levels. Typical direct air capture technologies require several GJ of energy input to sequester one metric ton of CO₂ without any useful byproducts other than supercritical CO₂, so the high cost of carbon capture currently limits widespread implementation of this technology.

Achieving climate targets established by the Intergovernmental Panel on Climate Change (IPCC) to avoid catastrophic climate warming will require broad-based decarbonization of all sectors, including industries where carbon emissions cannot be easily avoided by a shift to renewable energy. Manufacturing of ordinary Portland cement (OPC), the leading hydraulic cement, produces 0.9 tons of CO₂ emissions per ton of cement, because liming of the calcium carbonate raw feed emits stoichiometric quantities of CO₂ by the reaction: CaCO₃+heat→CaO+CO₂, and heat from fossil energy sources produces additional emissions. Few industries operate at commensurate scales to OPC production, but fertilizer production is one of them.

Formation of carbonate minerals represents a safe, stable, and permanent way to remove and sequester carbon dioxide, but mineral carbonation (MC) requires both a source of calcium and a source of alkalinity, e.g., as follows:

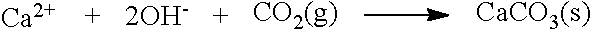

Over geologic timescales, the weathering of calcium-bearing silicate rocks at Earth's surface supplies the critical ingredients for MC to regulate the global atmospheric CO₂ concentration. However, these natural weathering reactions are not sufficiently fast to draw down excess anthropogenic CO₂ emissions.

Other examples of large-scale mineral carbonation process have been identified in the rock record associated with calcium sulfate mineral replacement reactions which have generated massive calcium carbonate limestone deposits, e.g., as follows:

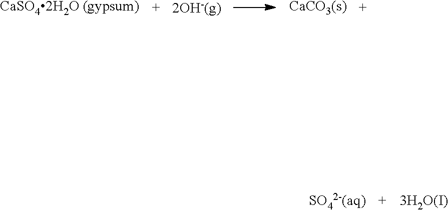

Formation of calcium carbonate minerals from gypsum (CaSO₄·2H₂O) has been suggested for permanent mineral carbon sequestration, as the replacement of gypsum by calcium carbonate can proceed rapidly to completion. The global fertilizer industry produces 100-280 Mt phosphogypsum (PG) waste powder per year as byproduct of sulfuric acid reaction with rock phosphorus.

### SUMMARY

The present inventors have realized that conventional lime generation processes supplying the feedstock for cement production suffer from certain inefficiencies and result in an unacceptable level of CO₂ greenhouse gas emission. As such, an improved process of lime generation for cement production is desirable. The methods and systems of the invention satisfy this desire.

Aspects of the invention include methods and systems that combine upcycling of waste gypsum to sulfuric acid with cement decarbonization. Methods of making a hydraulic cement are provided. Aspects of the methods include employing precipitated calcium carbonate (PCC), such as a CO₂ sequestering PCC, as a feedstock for lime (CaO) production. In some instances, methods include calcining the PCC to produce the lime. Methods of the invention may also involve employing the lime in the production of a clinker. In certain instances, the PCC is a carbon negative PCC (i.e., its production results in a net removal of carbon from the atmosphere). In some such instances, the carbon negative PCC is produced by a CO₂ sequestering protocol. Such protocols may include, for example, direct air capture (DAC). In certain cases, the CO₂ sequestering protocol employs solid calcium sulfate (e.g., as dihydrate, CaSO₄·2H₂O, hemihydrate, CaSO₄·0.5H₂O, or anhydrite, CaSO₄) as a feedstock. In some instances, the calcium sulfate comprises phosphogypsum. In some embodiments, the PCC is produced by an electrolytic protocol (i.e., the production of PCC involves electrolysis). In some such embodiments, the methods involve the use of an electrochemical salt splitting system such as an anion exchange membrane (AEM)-separated two-chamber cell system, a cation exchange membrane (CEM)-separated two-compartment cell system, a three-chamber cell system containing both an AEM and a CEM, or a bipolar membrane electrodialysis system comprising a stack of cells each containing an AEM, CEM, and a bipolar membrane. In certain cases, the AEM is configured so that sulfate anion crosses the membrane to the chamber where sulfuric acid is generated. Select embodiments of the methods also include maintaining a concentration of base in the catholyte or the center compartment that is low relative to the concentration of acid in the anolyte or the acid compartment, and recirculating fluid through the cathode chamber and the center compartment when present. One product of the subject methods may be sulfuric acid (H₂SO₄). Such H₂SO₄ may be employed and/or disposed of in any suitable manner. For example, the H₂SO₄ may in some versions be employed in hydrometallurgical extraction or recovery, such as via sulfuric acid leaching of lithium claystone or a magnesium silicate. In additional embodiments, the H₂SO₄ is employed in a fertilizer production process, thereby generating phosphogypsum and phosphoric acid. In some embodiments, the system includes a carbon dioxide removal system configured to receive a portion of base solution from the electrochemical system and generate an aqueous carbonate and bicarbonate solution using carbon dioxide derived from a gaseous source such as air or an industrial point source. In some cases the carbon negative PCC is produced in a carbonate precipitation system configured to receive solid calcium sulfate and the majority of (bi)carbonate solution from the carbonation system and to produce solid calcium carbonate minerals.

The hydraulic cement produced via the subject methods may be any convenient cement, such as an ordinary Portland cement (OPC). The cement may be employed for any suitable purpose, e.g., producing a concrete from the cement. Aspects of the inventions also include hydraulic cements produced via the methods of the disclosure, concretes prepared according to the methods of the present disclosure, and built structures produced from the hydraulic cements of the disclosure.

Aspects of the invention also include systems. Systems of interest include a carbonate precipitation reactor configured to produce PCC, and a calciner (e.g., a rotary calciner) in a precipitate-receiving relationship with the carbonate precipitation reactor. Systems of the invention may also include an electrolyzer stack of one or more salt splitting electrochemical cells comprising a two-chamber anion exchange membrane separated cell, a two-chamber cation exchange membrane separated cell, a three-chamber cell containing both an anion exchange membrane and a cation exchange membrane, or a bipolar membrane electrodialysis cell comprising an anion exchange membrane, a cation exchange membrane, and a bipolar membrane. In some instances, the carbonate precipitation reactor is configured to receive a hydroxide solution from the cathode or base chamber, to generate mineralized carbonate from a sulfate feedstock and CO₂, and to return some or all of the reactor solution to the salt splitting electrolyzer. Embodiments of the subject systems may also include a sulfuric acid recovery module configured to receive sulfuric acid from the anode chamber. In some cases, the system is configured as a continuous flow system. In certain versions of the invention, the carbonate precipitation reactor is operably connected to a source of sulfate (e.g., calcium sulfate). The carbonate precipitation reactor may be operably connected to a source of CO₂, such as air or a flue gas.

### BRIEF DESCRIPTION OF THE FIGURES

FIG. 1 provides a flow chart describing a process that combines water electrolysis for phosphogypsum upcycling and precipitated calcium carbonate production to generate a low-carbon hydraulic cement, in accordance with embodiments of the invention.

FIG. 2 depicts a system that combines water electrolysis for phosphogypsum upcycling and precipitated calcium carbonate production to generate a low-carbon hydraulic cement, in accordance with embodiments of the invention.

FIG. 3 presents a schematic diagram of an electrolyzer and reactor for mineral carbon sequestration by carbonation of gypsum with production of sulfuric acid.

FIGS. 4A-4B present intensity and CO₂ utilization data from a bench-top test of the process at two acid concentrations.

### DETAILED DESCRIPTION

Methods of making a hydraulic cement are provided. Aspects of the methods include employing precipitated calcium carbonate (PCC), such as a CO₂ sequestering PCC, as a feedstock for lime (CaO) production. Also provided are hydraulic cements and concretes produced by methods of embodiments of the invention, as well as products produced therefrom. In addition, systems for practicing methods of embodiments of the invention are provided.

Before the present invention is described in greater detail, it is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

Certain ranges are presented herein with numerical values being preceded by the term “about.” The term “about” is used herein to provide literal support for the exact number that it precedes, as well as a number that is near to or approximately the number that the term precedes. In determining whether a number is near to or approximately a specifically recited number, the near or approximating unrecited number may be a number which, in the context in which it is presented, provides the substantial equivalent of the specifically recited number.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, representative illustrative methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

It is noted that, as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

While the apparatus and method has or will be described for the sake of grammatical fluidity with functional explanations, it is to be expressly understood that the claims, unless expressly formulated under 35 U.S.C. § 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 U.S.C. § 112 are to be accorded full statutory equivalents under 35 U.S.C. § 112.

### Methods of Producing a Hydraulic Cement

As discussed above, methods of the invention involve making a hydraulic cement by employing precipitated calcium carbonate (PCC) as a feedstock for lime (CaO) production. The term “hydraulic cement” is employed in its conventional sense to refer to a composition which sets and hardens after combining with water or a solution where the solvent is water, e.g., an admixture solution. In some cases, the hydraulic cement comprises an ordinary Portland cement (OPC). As is known in the art, Portland cements are powder compositions produced by grinding Portland cement clinker (more than 90%), a limited amount of calcium sulfate which controls the set time, and up to 5% minor constituents (as allowed by various standards). Other hydraulic cements of interest in certain embodiments are Portland cement blends. The phrase “Portland cement blend” includes a hydraulic cement composition that includes a Portland cement component and significant amount of a non-Portland cement component. The Portland cement component may be a Portland cement produced by the methods of the invention. In certain embodiments, the hydraulic cement may be a blend of two or more different kinds of hydraulic cements, such as Portland cement and a carbonate containing hydraulic cement. In certain embodiments, the amount of a first cement, e.g., Portland cement in the blend ranges from 10 to 90% (w/w), such as 30 to 70% (w/w) and including 40 to 60% (w/w), e.g., a blend of 80% ordinary Portland cement (OPC) and 20% carbonate hydraulic cement.

“PCC” is discussed herein in its conventional sense to refer to calcium carbonate (CaCO₃) that is produced via artificial or synthetic means. Put another way, PCC described in the instant disclosure is distinct from natural ground calcium carbonate (GCC). For example, PCC is not limestone that had been produced (e.g., mined) by natural processes. Additionally, PCC for use in embodiments of the invention may not constitute calcium carbonate that is a product of an organism, including but not limited to gastropod shells, eggshells, and shellfish skeletons. In some cases, the PCC employed in the invention is, at the time of its use, precipitated relatively recently with respect to the geologic time scale, such as 100 years ago or less, 90 years ago or less, 80 years ago or less, 70 years ago or less, 60 years ago or less, 50 years ago or fewer, 40 years ago or less, 30 years ago or less, 20 years ago or less, 10 years ago or less, 5 years ago or less, 1 year ago or less, 6 months ago or less, 3 months ago or less, 1 month ago or less, 15 days ago or less, 10 days ago or less, 5 days ago or less, 1 day ago or less, 10 hours ago or less, 5 hours ago or less, 1 hour ago or less, 30 minutes ago or less, 10 minutes ago or less, and including 5 minutes ago or less.

Any suitable PCC may be employed in the subject methods. Techniques for PCC production that may be adapted for use in the subject methods are described in, e.g., U.S. Pat. Nos. 8,883,098; 8,936,771; 9,371,241; 9,725,330; 9,944,535; 9,981,855; 10,343,929; 10,399,862; 10,280,309; 11,447,641; the disclosures of which are herein incorporated by reference in their entirety. The PCC may consist of any convenient form of calcium carbonate. In some instances, the PCC is in a form selected from calcite, aragonite, vaterite, and amorphous calcium carbonate, or combinations thereof. In some cases, PCC of the invention comprises calcite. In additional embodiments, PCC of the invention comprises aragonite. In still additional embodiments, PCC of the invention comprises vaterite. In still additional embodiments, PCC of the invention comprises amorphous calcium carbonate or a combination of crystalline and amorphous calcium carbonate. In some instances, the PCC is a carbon negative PCC. The term “carbon negative” when used with reference to a product or component of the invention (e.g., PCC) refers to a reduction of atmospheric carbon dioxide resulting from the production of that product or component. In some such instances, the carbon negative PCC is produced by a CO₂ sequestering protocol. Any protocol for sequestering gaseous CO₂ may be employed. In embodiments, practicing the subject methods to obtain a hydraulic cement results in a net CO₂ emissions reduction. The net CO₂ emissions reduction (as compared to conventional methods of hydraulic cement production) may be by 5% or more, 10% or more, 15% or more, 20% or more, 25% or more, 30% or more, 35% or more, 40% or more, 45% or more, 50% or more, 55% or more, 60% or more, 65% or more, 70% or more, 75% or more and including 80% or more.

In select embodiments, the PCC is produced via the conversion of calcium sulfate to calcium carbonate. Any convenient source of calcium sulfate may be employed. In some cases, the source of calcium sulfate is an aqueous leachate stream containing calcium sulfate (>0.1 M) in addition to other dissolved aqueous species. In some versions, the calcium sulfate is solid dihydrate gypsum (CaSO₄·2H₂O), hemihydrite (CaSO₄·0.5H₂O), or anhydrite (CaSO₄). In other words, in methods according to certain embodiments of the invention, producing PCC includes employing solid calcium sulfate as a feedstock. Where gypsum is employed, it may be obtained from any convenient source. In some instances, the gypsum is mined gypsum. In other cases, the gypsum is synthetic gypsum. In some such cases, solid calcium sulfate for use in the subject methods are produced as a by-product or waste product of some other process. For example, in some instances, the gypsum employed in the subject methods is obtained from a flue gas desulfurization process. Flue gas desulfurization is described in, e.g., U.S. Pat. Nos. 8,425,868; 8,795,416; 9,097,158; and 9,192,890; the disclosures of which are herein incorporated by reference in their entirety.

In select versions of the methods, the solid calcium sulfate comprises phosphogypsum. Phosphogypsum is discussed herein in its conventional sense to describe the calcium sulfate of varied hydration states generally formed as a byproduct of phosphorus fertilizer production protocols. Such protocols often involve the use of sulfuric acid (H₂SO₄) in treating phosphate ore. In some cases, the generation of phosphogypsum proceeds as follows:

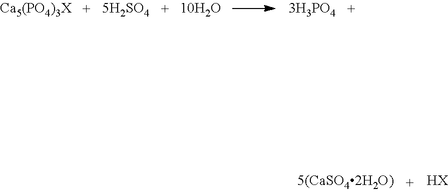

The “X” in the above reaction may, in some cases, be F⁻, OH⁻, Br⁻, or Cl⁻. Phosphogypsum may also include one or more of the following: SiO₂, Cd, Al, Ba, Pb, Cr, Se, U, Fe, P, Th, Ra, and Rare Earth Elements (REEs). Phosphoric acid (H₃PO₄), produced in the above-described reaction, is often applied in phosphate fertilizer production. In some cases, phosphogypsum used in the subject methods is a result of sulfuric acid reaction with rock phosphorus in fertilizer production. Phosphate fertilizers of interest include, e.g., diammonium phosphate (DAP), monoammonium phosphate (MAP), and triple super phosphate (TSP). Phosphate fertilizer production is described in, e.g., U.S. Pat. Nos. 3,856,500; 3,956,464; 4,321,078; 5,433,766; 6,322,607; 7,497,891; 8,506,670; and 9,764,993; the disclosures of which are incorporated by reference herein in their entirety.

In certain cases, the conversion of the calcium sulfate (e.g., gypsum) to calcium carbonate (i.e., PCC) occurs by reacting the calcium sulfate with a CO₂ containing gas and alkalinity. The CO₂ containing gas for use in the conversion of the calcium sulfate to PCC may be obtained from any convenient source. The CO₂ containing gas may be pure CO₂ or be combined with one or more other gasses and/or particulate components, depending upon the source, e.g., it may be a multi-component gas (i.e., a multi-component gaseous stream). While the amount of CO₂ in such gasses may vary, in some instances the CO₂ containing gasses have a pCO₂ of 10³ or higher, such as 10⁴ Pa or higher, such as 10⁵ Pa or higher, including 10⁵ Pa or higher. The amount of CO₂ in the CO₂ containing gas, in some instances, may be 20,000 or greater, e.g., 50,000 ppm or greater, such as 100,000 ppm or greater, including 150,000 ppm or greater, e.g., 500,000 ppm or greater, 750,000 ppm or greater, 900,000 ppm or greater, up to including 1,000,000 ppm or greater (In pure CO₂ exhaust the concentration is 1,000,000 ppm) In some instances may range from 10,000 to 500,000 ppm, such as 50,000 to 250,000 ppm, including 100,000 to 150,000 ppm. The temperature of the CO₂ containing gas may also vary, ranging in some instances from 0 to 1800° C., such as 100 to 1200° C. and including 600 to 700° C.

In some instances, the CO₂ containing gasses are not pure CO₂, in that they contain one or more additional gasses and/or trace elements. Additional gasses that may be present in the CO₂ containing gas include, but are not limited to water, nitrogen, mononitrogen oxides, e.g., NO, NO₂, and NO₃, oxygen, HF and other volatile fluoride compounds, sulfur, monosulfur oxides, (e.g., SO, SO₂ and SO₃), volatile organic compounds, e.g., benzo(a)pyrene C₂OH₁₂, benzo(g,h,l)perylene C₂₂H₁₂, dibenzo(a,h)anthracene C₂₂H₁₄, etc. Particulate components that may be present in the CO₂ containing gas include, but are not limited to particles of solids or liquids suspended in the gas, e.g., heavy metals such as strontium, barium, mercury, thallium, etc.

In certain embodiments, CO₂ containing gasses are obtained from an industrial plant, e.g., where the CO₂ containing gas is a waste feed from an industrial plant. Industrial plants from which the CO₂ containing gas may be obtained, e.g., as a waste feed from the industrial plant, may vary. Industrial plants of interest include, but are not limited to, power plants and industrial product manufacturing plants, such as but not limited to chemical, fertilizer, biofuel, and mechanical processing plants, refineries, cement plants, steel plants, etc., as well as other industrial plants that produce CO₂ as a byproduct of fuel combustion or other processing step (such as calcination by a cement plant or CO₂ off gassing by a phosphoric acid plant). Waste feeds of interest include gaseous streams that are produced by an industrial plant, for example as a secondary or incidental product, of a process carried out by the industrial plant.

Of interest in certain embodiments are waste streams produced by industrial plants that combust fossil fuels, e.g., coal, oil, natural gas, as well as man-made fuel products of naturally occurring organic fuel deposits, such as but not limited to tar sands, heavy oil, oil shale, etc. In certain embodiments, power plants are pulverized coal power plants, supercritical coal power plants, mass burn coal power plants, fluidized bed coal power plants, gas or oil-fired boiler and steam turbine power plants, gas or oil-fired boiler simple cycle gas turbine power plants, and gas or oil-fired boiler combined cycle gas turbine power plants. Of interest in certain embodiments are waste streams produced by power plants that combust syngas, i.e., gas that is produced by the gasification of organic matter, e.g., coal, biomass, etc., where in certain embodiments such plants are integrated gasification combined cycle (IGCC) plants. Of interest in certain embodiments are waste streams produced by Heat Recovery Steam Generator (HRSG) plants. Waste streams of interest also include waste streams produced by cement plants. Cement plants whose waste streams may be employed in methods of the invention include both wet process and dry process plants, which plants may employ shaft kilns or rotary kilns, and may include pre-calciners. Each of these types of industrial plants may burn a single fuel, or may burn two or more fuels sequentially or simultaneously. A waste stream of interest is industrial plant exhaust gas, e.g., a flue gas. By “flue gas” is meant a gas that is obtained from the products of combustion from burning a fossil or biomass fuel that are then directed to the smokestack, also known as the flue of an industrial plant.

In some instances, the CO₂ sequestering protocol comprises direct air capture (DAC). DAC encompasses a class of technologies and methods capable of separating carbon dioxide CO₂ directly from ambient air. A DAC system of the invention may be any system that captures CO₂ directly from air and generates a product that includes CO₂ at a higher concentration than that of the air that is input into the DAC system or that generates dissolved aqueous carbonate solution. DAC systems are systems that extract CO₂ from the air using media that binds to CO₂ but not to other atmospheric chemicals (such as nitrogen and oxygen). As air passes over the CO₂ binding medium, CO₂ “sticks” to the binding medium. DAC systems of interest include, but are not limited to: hydroxide based systems and CO₂ sorbent/temperature swing based systems. In some instances, the DAC system is a hydroxide based system, in which CO₂ is separated from air by contacting the air with is an aqueous hydroxide liquid. Examples of hydroxide based DAC systems include, but are not limited to, those described in PCT published application Nos. WO/2009/155539; WO/2010/022339; WO/2013/036859; and WO/2013/120024; the disclosures of which are herein incorporated by reference. Where hydroxide-based systems are employed, capture of CO₂ in an aqueous hydroxide may proceed as follows:

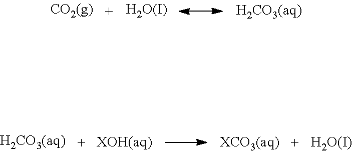

where X is a suitable counterion. In some cases, the method can use gases containing concentrated carbon dioxide by bubbling gas directly through a solution in which CaCO₃ precipitation is occurring using a disseminator or other suitable system to produce gas bubbles. In some cases, the DAC system can include an air contactor configured as a cooling tower, except the volumetric flux of air relative to that of hydroxide solution is approximately 50 times higher than standard cooling towers.

In some embodiments, the PCC is produced using an electrolytic protocol. “Electrolysis” is referred to in its conventional sense to refer to a chemical reaction that is driven by an electric current. In some embodiments, methods include applying the electrolytic protocol to an aqueous sulfate. Any suitable aqueous sulfate may be electrolyzed. In some cases, the aqueous sulfate is sodium sulfate (Na₂SO₄), potassium sulfate (K₂SO₄), calcium sulfate (CaSO₄), magnesium sulfate (MgSO₄), or the like. In embodiments, the electrolysis reaction proceeds as follows:

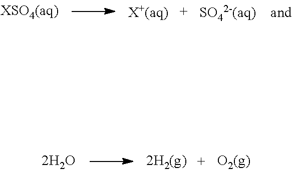

where X is a suitable counterion. Remaining water, hydrogen ions (H⁺), and sulfate ions (SO₄²⁻) comprise a sulfuric acid solution. In addition, hydrogen (H₂) and oxygen (O₂) gasses are evolved. Electrolytic protocols for use in the subject methods may vary. While the current applied to an electrolyzer in embodiments of the invention may vary, in some instances the applied current ranges from 60 to 600 mA/cm² such as 150 to 300 mA/cm². Electrolytic protocols may have any convenient source of electricity. In some instances, the source of electricity for the process is a low-carbon energy source generated by solar, wind, hydroelectric, geothermal, hydrogen, nuclear, or fusion power plants, with or without battery energy storage, that can optionally be purchased from the electrical grid.

In certain cases, the electrolytic protocol involves applying an electric current to drive the conversion of calcium sulfate to PCC. For example, methods may include subjecting calcium sulfate (e.g., gypsum, phosphogypsum), a base (i.e., OH⁻) and carbon dioxide to electrolysis to produce PCC, aqueous sulfate, and water. In select embodiments, the electrolytic protocol of the instant methods proceeds, as follows:

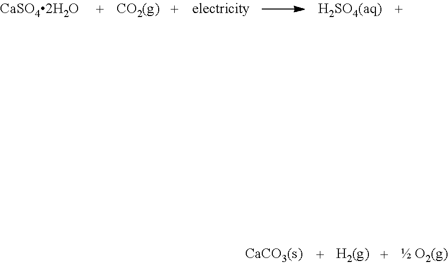

As shown above, sulfuric acid (H₂SO₄, PCC (CaCO₃), hydrogen gas (H₂) and oxygen gas (O₂) are products of the above-described embodiment of the electrolytic protocol. In other words, sulfuric acid (0.1-1 M), base (e.g. aqueous NaOH+Ca(OH)₂), green hydrogen, and oxygen are produced by water electrolysis in aqueous sulfate solution.

Accordingly, an embodiment of the invention provides a method to sequester carbon dioxide as PCC, and produce sulfuric acid by reacting sulfate solids, e.g., calcium sulfate solids, with electrochemically produced hydroxide solution contacted with carbon dioxide directly from air or from a more concentrated source, e.g., industrial exhaust gasses, power plant flue gasses, etc. In an aspect the invention provides electrochemical production of sulfuric acid and solid calcium carbonate (e.g., as calcite, aragonite or vaterite) from solid calcium sulfate, and carbon dioxide, with applications to mineral carbon sequestration, industrial fertilizer production, and green cement production.

In some embodiments, electrolyzers of interest include an electrolyzer stack of one or more electrochemical cells comprising an anode within an anode chamber containing an anolyte, a cathode within a cathode chamber containing a catholyte, and an anion exchange membrane separating the anode and cathode chambers. Exemplary electrolysis protocols according to such embodiments may be found in International Application No. PCT/US2022/039829, filed on Aug. 9, 2022; herein incorporated by reference in its entirety. In certain cases, the anion exchange membrane is configured so that sulfate anion crosses the anion exchange membrane to the anode chamber where sulfuric acid is generated. Methods may include maintaining a low concentration of base (OH⁻) in the catholyte relative to the concentration of acid (H⁺) in the anolyte, where in some instances the magnitude of the H⁺:OH⁻ ratio ranges from 5 to 100,000, such as 10 to 100 and including 2 to 200,000, where the relatively lower concentration of base is provided by flowing the catholyte through the cathode chamber, e.g., as a total stack flow rate ranging in some instances from 300 to 10,000 liters per minute (L/min) such as 500 to 1,000 L/min for a 1 metric ton CO₂ mineralization per day system, e.g., by recirculating fluid from the reactor through the cathode chamber.

In some embodiments, calcium sulfate is introduced to a mineral precipitation reactor where it is converted to calcium carbonate by reaction with carbon dioxide from air and alkalinity produced in a two-chamber water electrolyzer. Effluent from the precipitation reactor is recirculated through the cathode chamber of the water electrolyzer, where sulfate liberated crosses an anion exchange membrane to gradually accumulate sulfuric acid in a recirculating anolyte solution. During operation, sulfuric acid and calcium carbonate are produced by reacting a calcium sulfate source with electrochemically produced hydroxide contacted with carbon dioxide derived from atmospheric air, although more concentrated sources of carbon dioxide can also be used (e.g., as discussed above).

In addition, methods according to some embodiments may include generating an acid concentration in the anolyte that is higher than the base concentration in the catholyte even though protons and hydroxides are produced at the same rate in the electrochemical cell where in some instances the magnitude of the acid to base concentration ratio ranges from 5 to 100,000, such as 10 to 100. In addition, methods may include recirculating water at a constant rate through the anode chamber to allow for accumulation of sulfuric acid, e.g., at a total stack flow rate ranging in some instances from 15 to 100 L/min, such as 60 to 90 L/min and including 10 to 300 L/min for a 1 metric ton CO₂ mineralization per day system.

In certain other embodiments, the electrolyzers of interest are configured as a three-compartment system designed to produce concentrated acid solutions at concentrations between 0.05 to >2.0 M, such as 1 M, and concentrated hydroxide solutions at concentrations between 0.5 to 2.0 M, such as 1 M, with production of gaseous hydrogen and oxygen. Hydroxide solution concentrations >0.5 M are suitable for direct air capture of carbon dioxide using an air contactor. The system includes a cell or stack of cells consisting of an anode compartment separated from the sulfate feed solution compartment by an AEM as well as a cathode compartment separated from the sulfate feed solution compartment by a CEM. In still other embodiments, the electrochemical unit configured as a BMED system is designed to produce concentrated acid solutions at concentrations between 0.05 to >2.0 M and concentrated hydroxide solutions at concentrations between 0.5-2.0 M, and with the concentrated hydroxide solution suitable for direct air capture of carbon dioxide using an air contactor.

In embodiments, the process avoids the usual pitfalls of electrochemical acid-base production by maintaining a low concentration of OH⁻ in the catholyte solution, such that the ratio of sulfate (SO₄²⁻) to hydroxide (OH⁻) in the catholyte is greater than 10. This configuration ensures that the flux of sulfate ions across the anion exchange membrane (AEM) is greater than the flux of hydroxide ions, minimizing Faradaic losses and increasing energy efficiency. The precipitation of carbonate, hydroxide, and hydroxycarbonate minerals consumes alkalinity, so the concentration of produced sulfuric acid is greater than the concentration of hydroxide in the catholyte by a factor of 5 or greater. Suitable AEMs minimize voltage by allowing a sufficiently high sulfate flux, while limiting proton leakage, and are durable over the pH range 0-14.

In embodiments, methods include maintaining a relatively low concentration of base (OH⁻) in the catholyte or center compartment relative to the concentration of acid (H⁺) in the anolyte by recirculating fluid from mineralization through the cathode chamber and center compartment rather than using the same solution feeds into all chambers, such that although protons and hydroxides are produced at the same rate in the electrochemical cell, the system generates an acid concentration in the anolyte that is much higher than (by at least about 5 times to about 200,000 times) the base concentration in the catholyte or the center compartment, because the fluids are circulated separately, which (i) minimizes Faradaic losses by migration of OH⁻ across the anion exchange membrane and resulting loss reaction: OH⁻+H⁺→H₂O in the electrochemical cell and (ii) protects the anion exchange membrane from degradation in strong base. In embodiments, methods also include sequestering carbon dioxide as mineralized carbonate, e.g., calcium carbonate, and produce sulfuric acid by reacting sulfate solids, e.g., calcium sulfate solids, with electrochemically produced hydroxide solution contacted with carbon dioxide directly from air or from a more concentrated source.

In systems configured to receive dilute sulfuric acid and concentrated base, the electrolyzer of interest configured as a CEM system is designed to produce sulfuric acid at concentrations between 0.05-0.5M and concentrated hydroxide solutions at concentrations between 0.5-2.0 M with production of hydrogen and oxygen. The concentrated hydroxide solution is suitable for direct air capture of carbon dioxide using an air contactor. The produced sulfuric acid can contain a substantial concentration of sodium sulfate salt, from 0.25 to 1M, such as 0.25-0.5M, or 0.4-0.6M or >0.5M.

In some cases, methods include cyclic steps of electrochemical production of sulfuric acid at the anode and a hydroxide aqueous solution, e.g., calcium hydroxide aqueous solution, at the cathode, wherein the hydroxide solution is reacted with carbon dioxide to produce solid carbonate, e.g., solid calcium carbonate. In embodiments, methods include cyclic steps of electrochemical production of sulfuric acid at the anode and hydroxide aqueous solution, e.g., calcium hydroxide aqueous solution, at the cathode, wherein the hydroxide solution is reacted with carbon dioxide and divalent cation, e.g., calcium or magnesium ion, to produce a solid carbonate, e.g., PCC, wherein the sulfuric acid anolyte is recovered, concentrated as desired, e.g., to >70% H₂SO₄, and in some instances reacted with rock phosphorus to produce phosphoric acid, calcium sulfate, and HF, wherein the product calcium sulfate is returned to the process to produce calcium carbonate and sulfate solution, wherein the sulfate solution is returned to the electrochemical cell along with water to continue the cycle.

In embodiments of the subject methods, the products of the electrolysis protocols may have various uses. The PCC (CaCO₃) is converted to lime (CaO) as described in greater detail below. In select cases, such lime may be slaked to form calcium hydroxide (Ca(OH)₂), which may in some cases be used to form lime mortar. In embodiments, the oxygen gas produced at the anode is off-gassed to the atmosphere, is collected to be compressed and sold, or is used as an oxidant in the sulfuric acid extraction process to avoid sulfate-reducing conditions. In addition, the hydrogen gas may be collected and employed, as desired. For example, synthesized H₂ may be employed, e.g., as fuel source, e.g., for transportation, power production, ammonia production, etc. For example, the synthesized H₂ may be employed in a hydrogen fuel cell, e.g., in an automobile. In additional instances, synthesized H₂ may be employed as a hydrogen feedstock for chemical synthesis. In some embodiments, methods include storing the synthesized H₂, e.g., for later use. In some such embodiments, the synthesized H₂ is stored as a gas. For example, gaseous H₂ may be stored under pressure (e.g., 5,000-10,000 psi) in a gas tank. In some cases, methods include storing H₂ as a liquid (e.g., under cryogenic temperatures such as −253° C.).

Sulfuric acid produced as described above may find multiple uses. As described above, sulfuric acid is often employed in phosphate fertilizer production. As such, embodiments of the invention include employing the produced sulfuric acid in phosphate fertilizer production. In some embodiments, methods include concentrating the produced sulfuric acid prior to employing it for phosphate fertilizer production. When concentrated, the concentration of the sulfuric acid may be, for example, 0.5 M or more, such as 0.6 M or more, such as 0.7 M or more, such as 0.8 M or more, such as 0.9 M or more, such as 1 M or more, such as 1.1 M or more, such as 1.2 M or more, such as 1.3 M or more, such as 1.4 M or more, and including 1.5 M or more. As noted above, a byproduct of phosphorous fertilizer production is phosphogypsum. Such phosphogypsum may then be used to create more PCC, and so on. In some cases, the sulfate is substantively recycled to reduce the accumulation of sulfate wastes during mining and fertilizer production.

In addition to or instead of treating phosphate ore to obtain phosphoric acid, the sulfuric acid produced as described above may be employed in hydrometallurgical extraction or recovery. For example, sulfuric acid can be employed in the mining of metals such as nickel, copper, and lithium. In aspects, the produced sulfuric acid is used to extract critical elements and carbon dioxide reactive elements (e.g., calcium and magnesium) from silicate rocks. In still additional embodiments, methods include sulfuric acid leaching of lithium claystone or other magnesium or calcium silicate using sulfuric acid generated during the production of PCC as discussed herein.

Methods according to embodiments of the invention additionally include a precipitation step in which calcium carbonate is precipitated to form PCC. In some embodiments, PCC formation occurs according to the following reaction:

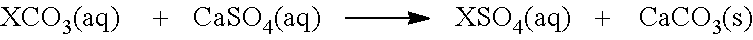

where X is a suitable counterion. While the source of carbonate may in some instances vary, methods according to some embodiments include receiving the carbonate (XCO₃) from the reaction of base with carbon dioxide (e.g., as discussed above) during a carbon capture process. Similarly, while the source of calcium sulfate (CaSO₄) may vary, the calcium sulfate may in some cases be from a gypsum source or a phosphogypsum source. In some instances, the source of calcium sulfate is phosphogypsum produced as a result of fertilizer production (e.g., discussed in detail herein).

In some cases, a solvent may be added to the calcium sulfate (e.g., gypsum or phosphogypsum) to form a solution, slurry or suspension prior to reacting with the carbonate source. Suitable solvents that may be used for forming a gypsum solution, slurry, or suspension include aprotic polar solvents, polar protic solvents, and non-polar solvents. Suitable aprotic polar solvents may include, but are not limited to, propylene carbonate, ethylene carbonate, butyrolactone, acetonitrile, benzonitrile, nitromethane, acetonitrile, nitrobenzene, sulfolane, dimethylformamide, N-methylpyrrolidone, or the like. Suitable polar protic solvents may include, but are not limited to, water, nitromethane, and short chain alcohols. Suitable short chain alcohols may include, but are not limited to, one or more of methanol, ethanol, propanol, isopropanol, butanol, or the like. Suitable non-polar solvents may include, but are not limited to, cyclohexane, octane, heptane, hexane, benzene, toluene, methylene chloride, carbon tetrachloride, or diethyl ether. Co-solvents may also be used. In a certain embodiment, the solvent added to gypsum is water. To form a slurry or suspension, an amount of water is added to partially dissolve the gypsum, such that some of the gypsum is fully dissolved and some of the gypsum remains in solid form. In another embodiment, water is added to gypsum to form a slurry, wherein the percent of solids in the slurry is 10-50%, or 20-40%, or 30-35%.

Calcium carbonate can be precipitated from aqueous solution in one or more different compositional forms: vaterite, calcite, aragonite, amorphous, or a combination thereof. Generally, vaterite, calcite, and aragonite are crystalline compositions and may have different morphologies or internal crystal structures, such as, for example, rhombic, orthorhombic, hexagonal, or variations thereof. The calcite form is the most stable form and the most abundant in nature and may have one or more of several different shapes, for example, rhombic and scalenohedral shapes. The rhombic shape is the most common for calcite and may be characterized by crystals having approximately equal lengths and diameters, which may be aggregated or unaggregated. Calcite crystals are commonly trigonal-rhombohedral. Scalenohedral crystals are similar to double, two-pointed pyramids and are generally aggregated. The aragonite form is metastable under ambient temperature and pressure but converts to calcite at elevated temperatures and pressures. The aragonite crystalline form may be characterized by acicular, needle- or spindle-shaped crystals, which are generally aggregated and which typically exhibit high length-to-width or aspect ratios. For instance, aragonite may have an aspect ratio ranging from about 3:1 to about 15:1. Aragonite may be produced, for example, by the reaction of carbon dioxide with slaked lime.

In the present disclosure, the crystalline content of a PCC composition may be readily determined through visual inspection by use of, for example, a scanning electron microscope or by X-ray diffraction or other spectroscopic method. Such determination may be based upon the identification of the crystalline form and is well known to those of skill in the art.

The PCC compositions may also be characterized by their particle size distribution (PSD). As used herein and as generally defined in the art, the median particle size (also called ds) is defined as the size at which 50 percent of the particle weight is accounted for by particles having a diameter less than or equal to the specified value. The PCC compositions may have a d₅₀ in a range from about 1 micron to about 150 microns, for example, from about 20 microns to about 120 microns, from about 2 to about 6 microns, from about 1 micron to about 4 microns, or from about 0.1 micron to about 1.5 microns. The d₅₀ may vary with the morphology of the PCC. For example, calcite PCC may have a d₅₀ in a range from about 10 to about 100 microns, such as, for example, from about 20 to about 50 microns, from about 10 to about 80 microns, from about 10 to about 50 microns, or from about 4 to about 6 microns. Vaterite PCC may have a d₅₀ in a range from about 0.1 microns to about 5 microns, such as, for example, from about 0.1 to about 2 microns, from about 1 to about 5 microns, or from about 2 to about 4 microns. In some embodiments, the PCC compositions may have a d₅₀ in a range from about 0.1 micron to about 15 microns, for example, from about 2 microns to about 12 microns, from about 2 to about 6 microns, from about 1 micron to about 4 microns, or from about 0.1 micron to about 1.5 microns. The d₅₀ may vary with the morphology of the PCC. For example, calcite PCC may have a d₅₀ in a range from about 0.1 to about 11 microns, such as, for example, from about 0.1 to about 2 microns, from about 1 to about 5 microns, from about 2 to about 4 microns, or from about 4 to about 6 microns. Vaterite PCC may have a d₅₀ in a range from about 0.1 microns to about 5 microns, such as, for example, from about 0.1 to about 2 microns, from about 1 to about 5 microns, or from about 2 to about 4 microns.

According to some embodiments, between about 30 percent and about 80 percent of the PCC particles are less than about 100 microns in diameter. In other embodiments, between about 55 percent and about 99 percent of the PCC particles are less than 100 microns in diameter. According to some embodiments, between about 30 percent and about 80 percent of the PCC particles are less than about 2 microns in diameter. In other embodiments, between about 55 percent and about 99 percent of the PCC particles are less than 2 microns in diameter. According to some embodiments, less than about 1 percent of the PCC particles are greater than 10 microns in diameter, such as, for example, less than 0.5 percent of the PCC particles are greater than 10 microns in diameter, or less than 0.1% of the PCC particles are greater than 10 microns in diameter.

The PCC compositions may be further characterized by their aspect ratio. The aspect ratio of the particles of a PCC composition may be determined by various methods. One such method involves first depositing a pigment slurry on a standard SEM stage and coating the slurry with platinum. Images are then obtained and the particle dimensions are determined, using a computer based analysis in which it is assumed that the thickness and width of the particles are equal. The aspect ratio may then be determined by averaging fifty calculations of individual particle length-to-width aspect ratios. The PCC compositions may also be characterized in terms of their cubicity, or the ratio of surface area to particle size (i.e., how close the material is to a cube, rectangular prism, or rhombohedron). In certain embodiments of the present disclosure, a lower surface area is advantageous. Smaller particles typically have much higher surface area, but small particle size is advantageous for many different applications. Thus PCC products with small particle size material and lower than “normal” surface area are particularly advantageous. Rhombic crystal forms are generally preferred in terms of cubicity.

According to some embodiments, the cubic nature of the PCC compositions may be determined by the “squareness” of the PCC particles. A squareness measurement generally describes the angles formed by the faces of the PCC particle. Squareness, as used herein, can be determined by calculating the angle between adjacent faces of the PCC, where the faces are substantially planar. Squareness may be measured using SEM images by determining the angle formed by the edges of the planar faces of the PCC particle when viewed from a perspective that is parallel to the faces being measured. According to some embodiments, the PCC compositions may have a squareness in a range from about 70 degrees to about 110 degrees.

In the present disclosure, the monodispersity of the product refers to the uniformity of crystal size and polymorphs. The steepness (d₇₀/d₃₀) refers to the particle size distribution bell curve, and is a monodispersity indicator. dx is the equivalent spherical diameter relative to which x % by weight of the particles are finer. According to some embodiments, the PCC may have a steepness in a range from about 1.0 to about 4.0, such as, for example, in a range from about 1.0 to about 3.0, from about 1.3 to about 2.4, from about 1.33 to about 2.31, from about 1.42 to about 2.17, from about 1.5 to about 2.0, from about 1.5 to about 1.7, or from about 1.53 to about 1.61. According to some embodiments, the PCC may have a steepness in a range from about 1.4 to about 5, such as, for example, in a range from about 2.0 to about 4.0. In some embodiments, the steepness may vary according to the morphology of the PCC. For example, calcite may have a different steepness than vaterite.

According to some embodiments, the PCC compositions may have a top-cut (d₉₀) particle size less than about 250 microns, such as, for example, less than about 170 microns, less than about 150 microns, less than about 120 microns, or less than about 100 microns. According to some embodiments, the PCC compositions may have a top-cut (d₉₀) particle size less than about 25 microns, such as, for example, less than about 17 microns, less than about 15 microns, less than about 12 microns, or less than about 10 microns. According to some embodiments, the PCC compositions may have a top-cut particle size in a range from about 5 microns to about 25 microns, such as, for example, in a range from about 15 microns to about 25 microns, from about 10 microns to about 20 microns, or from about 5 microns to about 15 microns.

According to some embodiments, the PCC compositions may have a bottom-cut (d₁₀) particle size less than about 3 microns, such as, for example, less than about 2 microns, less than about 1 micron, less than about 0.7 microns, less than about 0.5 microns, less than 0.3 microns, or less than 0.2 microns. According to some embodiments, the PCC compositions may have a bottom-cut particle size in a range from about 0.1 micron to about 3 microns, such as, for example, in a range from about 0.1 micron to about 1 micron, from about 1 micron to about 3 microns, or from about 0.5 microns to about 1.5 microns.

The PCC compositions may additionally be characterized by their Brunauer-Emmett-Teller (BET) surface area. The BET surface area may vary according to the morphology of the PCC. According to some embodiments, the PCC may have a BET surface area less than 40 m²/g, such as, for example, less than 30 m²/g, less than 20 m²/g, less than 15 m²/g, less than 10 m²/g, less than 5 m²/g, less than 1 m²/g, or less than 0.2 m²/g. In some embodiments, the calcite PCC composition particles have a surface area in a range from 0.2 to 15.0 m²/g, such as, for example, from 2 to 10 m²/g, from 3.3 to 6.0 m²/g, from 3.6 to 5.0 m²/g. In other embodiments, calcite PCC may have a BET surface area in a range from 1 to 6 m²/g, from 1 to 4 m²/g, from 3 to 6 m²/g, or from 1 to 10 m²/g, from 2 to 10 m²/g, or from 5 to 10 m²/g.

The PCC compositions may additionally be characterized by the ratio of BET surface area to d50. In a certain embodiment, the vaterite PCC composition particles have a ratio of BET surface area to d50 of 1.0-6.5, or 2.0-5.5, or 2.5-5.0. In another embodiment, the calcite PCC composition particles have a ratio of BET surface area to d50 of 0.6-2.0, or 0.7-1.8, or 0.8-1.5.

Following precipitation, calcium carbonate may be subjected to one or more further treatment steps. In some embodiments, methods include setting the PCC. The initial PCC composition can include not only compounds in the solid state, but also compounds in a liquid state, e.g., liquid water. “Setting” the PCC composition is used interchangeably with “drying” the solid composition and includes placing the solid composition in an environment such that there is evaporation of liquid from the solid composition. By removing a liquid from the solid composition, the chemical composition and thereby physical properties of the solid composition can be altered, e.g., a reduced volume of liquid can cause solutes dissolved in the liquid to transition to a solid state. For example, the initial PCC composition can be placed on a solid surface so that it is not in contact with another liquid, e.g., so that liquid from the solid composition can evaporate and the solid composition will not gain liquid from another liquid. In some cases, the composition is placed within a thickener configured to reduce the liquid content of the composition. Thickeners of interest have a funnel-like configuration having a wide inlet for receiving the PCC composition and a comparatively smaller outlet where processed PCC is output. Thickeners may also operate by maintaining a fluidized bed of settled slurry particles that pass to a filter press for solid-liquid separation, with thickener overflow water returned to the process. Liquid may subsequently evaporate while the composition thickens as it travels through the thickener. In some cases, methods include ways of increasing the rate of evaporation, e.g., flowing a gas past the solid composition, applying a reduced gas pressure to the solid composition, increasing the temperature of the solid composition, or a combination thereof. Flowing the gas past the solid composition can be performed, for example, with a fan. A pump, e.g., a vacuum pump, can be employed to reduce the gas pressure, thereby increasing the rate of evaporation. The temperature of the solid composition can be increased, e.g., using an electric heater or a natural gas heater, to a temperature such as ranging from 25° C. to 95° C., such as from 35° C. to 80° C. In embodiments, the setting can be done simply by air drying for 1-30 days or by drying with elevated temperature (for minutes-hours at 30-200° C.).

In some embodiments, methods include subjecting the PCC composition to a separation process. The term “separation process” is used herein in its conventional sense to refer to the conversion of a mixture of chemical substances to a plurality of different products. As discussed above, products of the precipitation process may include calcium carbonate (i.e., PCC) and aqueous sulfate. In some cases, the separation process includes separating water from the PCC. In additional cases, the separation process includes separating sulfate from the PCC. In still additional cases, the separation process includes separating an aqueous sulfate from the PCC. In select cases, the separation process involves the use of a filter press. Filter presses operate by injecting a slurry into one or more chambers. Pressure in the chambers is increased, and liquid is strained through a filter (e.g., using pressurized air or water). The type of filter press may vary. Examples include plate and frame filter presses, automatic filter presses, recessed plate filter presses, and membrane filter presses. Where aqueous sulfate is separated from the PCC composition, the aqueous sulfate may in some versions be returned to the electrolysis step.

Methods according to some embodiments of the invention include calcining the PCC to produce the lime. “Calcining” is referred to herein in its conventional sense to describe a thermal treatment process for bringing about a chemical change (e.g., thermal decomposition). Calcination of PCC is carried out according to the following reaction:

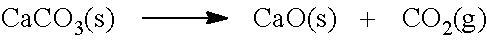

In the above reaction, CaCO₃(s) is the PCC (e.g., produced as described above) and CaO(s) is lime. Any convenient calcination process may be employed. Methods may include introducing the PCC into a calciner. Any convenient calciner may be adapted for use in the subject methods. Calciners of interest include rotary kilns, vertical kilns, flash kilns, and tunnel kilns. In some instances, calcining the PCC includes subjecting the PCC to a rotary calcination process. For example, methods of interest include placing the PCC in a rotary vessel (e.g., rotary calciner or rotary kiln). In certain embodiments, methods include passing the PCC through a rotating rotary vessel. In some cases, the rotary vessel is inclined. Rotation speeds of the rotary vessel may vary, and can range in some embodiments from 10 revolutions per hour to 500 revolutions per hour, such as 15 revolutions per hour to 400 revolutions per hour, such as 20 revolutions per hour to 350 revolutions per hour, such as 25 revolutions per hour to 300 revolutions per hour, such as 30 revolutions per hour to 250 revolutions per hour, and including 35 revolutions per hour to 200 revolutions per hour. In some cases where the rotary vessel is inclined, the incline ranges from 0° to 180°, such as 0° to 45°, and such as 0° to 10°, and including 1° to 4°. The calciner may operate at any temperature suitable for the calcination of PCC. In select cases, the calciner is configured to operate at a temperature ranging from 500° C. to 12,000° C., such as 900° C. to 1,050° C. In select cases, methods include combusting a material in order to generate the heat for calcination. In such cases, the requisite temperatures may be achieved by burning fuel such as gas, fuel oil, powdered coal, coke or the like, singularly or in combinations in the gaseous atmosphere of the kiln, with the gases moving countercurrent to the solids through the kiln. Additional details regarding calcination and various protocols therefor can be found in U.S. Pat. Nos. 4,002,420; 4,748,010; 5,156,676; 5,523,957; and 9,828,288; and U.S. Patent Application Publication No. 2014/0004473; the disclosures of which are incorporated by reference herein in their entirety.

In some embodiments, methods include employing the lime in the production of a clinker. As discussed herein, a clinker is a solid material generally existing in the form of nodules. The produced clinker may, in some cases, be a Portland clinker (i.e., that is used in the production of a Portland cement). In such cases, the clinker may comprise alite (Ca₃Si), belite (Ca₂Si), aluminate (e.g., tricalcium aluminate, Ca₃Al), and ferrite (e.g., calcium alminoferrite Ca₄AlFe). As defined by the European Standard EN197.1, “Portland cement clinker is a hydraulic material which shall consist of at least two-thirds by mass of calcium silicates (3CaO·SiO₂ and 2CaO·SiO₂), the remainder consisting of aluminum- and iron-containing clinker phases and other compounds. The ratio of CaO to SiO₂ shall not be less than 2.0. The magnesium content (MgO) shall not exceed 5.0% by mass.” The concern about MgO is that later in the setting reaction, magnesium hydroxide, brucite, may form, leading to the deformation and weakening and cracking of the cement. In the case of magnesium carbonate containing cements, brucite will not form as it may with MgO. In certain embodiments, the Portland cement constituent of the present invention is any Portland cement that satisfies the ASTM Standards and Specifications of C150 (Types I-VIII) of the American Society for Testing of Materials (ASTM C50-Standard Specification for Portland Cement). ASTM C150 covers eight types of Portland cement, each possessing different properties, and used specifically for those properties.

In some embodiments, methods include employing PCC as a replacement for ordinary Portland cement in blended hydraulic cements, such as replacement of 1-15% by mass of the ordinary Portland cement, such as 5%, 10% or 15% PCC. These ranges are typical of specifications for ASTM certified blended hydraulic cements following the ASTM C595/C595M Performance Specification as known to those skilled in the art.

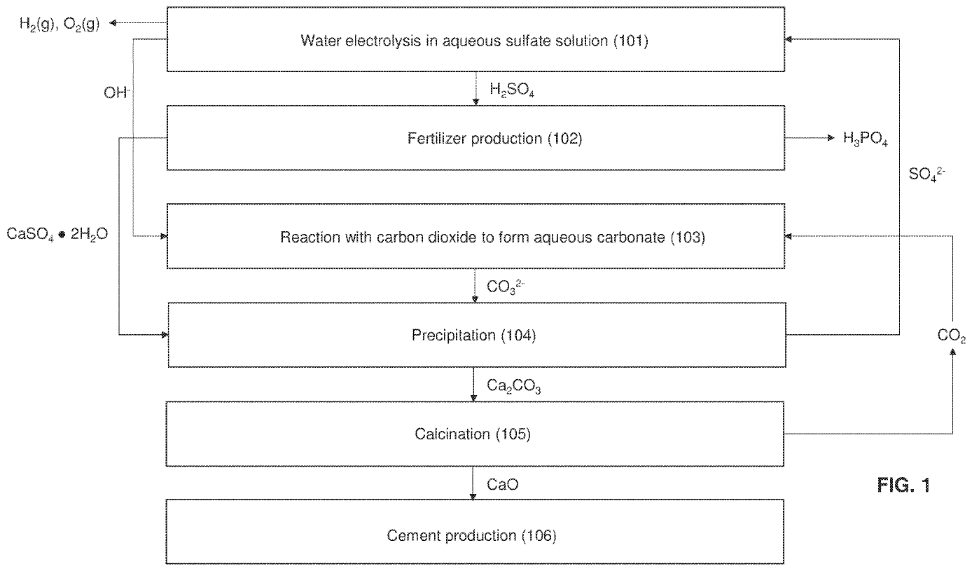

FIG. 1 presents a flowchart for practicing an embodiment of the subject methods. In step 101, water electrolysis occurs in an aqueous sulfate solution. Sulfuric acid (H₂SO₄), base (OH⁻), green hydrogen (H₂) and oxygen (O₂) are produced. The hydrogen may be collected for future use. For example, the hydrogen could be used in a hydrogen fuel cell. Oxygen may be vented to the atmosphere, or likewise collected for use in any suitable application. In step 102, the sulfuric acid produced in step 101 is used in fertilizer production. Products of the fertilizer production step include phosphoric acid (H₃PO₄)—which may be subjected to further processing steps to produce, e.g., one or more of diammonium phosphate (DAP), monoammonium phosphate (MAP), and triple super phosphate (TSP)—and phosphogypsum. In step 103, base produced in step 101 is reacted with carbon dioxide to form an aqueous carbonate (CO₃²⁻). The carbon dioxide may be from any source of gaseous CO₂. In some cases, the source of gaseous CO₂ is the air (i.e., the CO₂ is captured via DAC). In other cases, the source of gaseous CO₂ may be a point source (e.g., a flue gas), optionally from an industrial process such as cement production. In the example of FIG. 1, the CO₂ is captured via a hydroxide based DAC protocol. Carbonate ions from step 103 and gypsum from step 102 may be combined in a precipitation reaction to produce PCC (Ca₂CO₃). The resulting PCC is subsequently subjected to a calcination process (step 105) to produce lime (CaO), which is suitable for use in hydraulic cement production (step 106). CO₂ is produced as a result of the calcination process 105.

In some embodiments, methods include producing a concrete using the cement of the invention. As is known in the art, concrete comprises fine and course aggregates combined with a cement component. Any suitable concrete production protocol may be employed. Concrete production protocols that may be adapted are described in, for example, U.S. Pat. Nos. 1,723,631; 8,545,749; and 9,416,052; the disclosures of which are incorporated by reference herein in their entirety. In embodiments, settable compositions, such as concretes and mortars, are produced by combining a hydraulic cement of the invention with an amount of aggregate (fine for mortar, e.g., sand; coarse with or without fine for concrete) and water, either at the same time or by pre-combining the cement with aggregate, and then combining the resultant dry components with water. The choice of coarse aggregate material for concrete mixes using cement compositions of the invention may have a minimum size of about ⅜ inch and can vary in size from that minimum up to one inch or larger, including in gradations between these limits. Finely divided aggregate is smaller than ⅜ inch in size and again may be graduated in much finer sizes down to 200-sieve size or so. Fine aggregates may be present in both mortars and concretes of the invention. The weight ratio of cement to aggregate in the dry components of the cement may vary, and in certain embodiments ranges from 1:10 to 4:10, such as 2:10 to 5:10 and including from 55:1000 to 70:100.

In certain embodiments, the cements may be employed with one or more admixtures. Admixtures are compositions added to concrete to provide it with desirable characteristics that are not obtainable with basic concrete mixtures or to modify properties of the concrete to make it more readily useable or more suitable for a particular purpose or for cost reduction. As is known in the art, an admixture is any material or composition, other than the hydraulic cement, aggregate and water, that is used as a component of the concrete or mortar to enhance some characteristic, or lower the cost, thereof. The amount of admixture that is employed may vary depending on the nature of the admixture. In certain embodiments the amounts of these components range from 1 to 50% w/w, such as 2 to 10% w/w.

Admixtures of interest include finely divided mineral admixtures such as cementitious materials; pozzolans; pozzolanic and cementitious materials; and nominally inert materials. Pozzolans include diatomaceous earth, opaline cherts, clays, shales, fly ash, silica fume, volcanic tuffs and pumicites are some of the known pozzolans. Certain ground granulated blast-furnace slags and high calcium fly ashes possess both pozzolanic and cementitious properties. Nominally inert materials can also include finely divided raw quartz, dolomites, limestone, marble, granite, and others. Fly ash is defined in ASTM C618. Other types of admixture of interest include plasticizers, accelerators, retarders, air-entrainers, foaming agents, water reducers, corrosion inhibitors, and pigments.

As such, admixtures of interest include, but are not limited to: set accelerators, set retarders, air-entraining agents, defoamers, alkali-reactivity reducers, bonding admixtures, dispersants, coloring admixtures, corrosion inhibitors, dampproofing admixtures, gas formers, permeability reducers, pumping aids, shrinkage compensation admixtures, fungicidal admixtures, germicidal admixtures, insecticidal admixtures, rheology modifying agents, finely divided mineral admixtures, pozzolans, aggregates, wetting agents, strength enhancing agents, water repellents, and any other concrete or mortar admixture or additive. Admixtures are well-known in the art and any suitable admixture of the above type or any other desired type may be used; see, e.g., U.S. Pat. No. 7,735,274, incorporated herein by reference in its entirety.

Aspects of the invention further include producing structures from the hydraulic cements and concretes of the disclosure. As such, further embodiments include manmade structures that contain the hydraulic cements of the invention and methods of their manufacture. The manmade structure may be any structure in which an aggregate may be used, such as a building, dam, levee, roadway or any other manmade structure that incorporates an aggregate or rock. In some embodiments, the invention provides a manmade structure, e.g., a building, a dam, or a roadway, that includes a cement of the invention.

### Systems for Producing a Hydraulic Cement

As discussed above, aspects of the invention also include systems. Systems of interest include a carbonate precipitation reactor configured to produce precipitated calcium carbonate (PCC), and a calciner in a precipitate-receiving relationship with the carbonate precipitation reactor. The carbonate precipitation reactor may be any suitable device configured to produce PCC. The carbonate precipitation reactor may be configured to produce PCC, for example, via a process described above in the Methods section.

Carbonate precipitation reactors of the subject systems may include a precipitation reactor. Any device suitable for the precipitation of CaCO₃ may be employed as the subject precipitation reactor. In some embodiments, the precipitation reactor is operably connected to a source of calcium sulfate and a source of carbonate. The source of calcium sulfate may be any convenient source, and can include gypsum and phosphogypsum (e.g., as discussed above). The precipitation reactor may introduce the reagents in any suitable manner (e.g., disintegration and/or spraying, etc.). In some cases, the precipitation reactor is a continuous flow mixer. Precipitation reactors may additionally an agitator configured to mix the slurry undergoing precipitation. Agitators of interest may include one or more sets of rotors and blades. Where multiple rotors are employed, embodiments of the precipitation reactor include rotors rotating in opposite directions or in the same directions at different speeds. The blades, or the like, can create shear forces, turbulence and under and overpressure pulses, which grind, or disintegrate and spray the material. Precipitation reactors that may be adapted for use are described in, e.g., U.S. Pat. No. 8,012,445, the disclosure of which is incorporated by reference herein.

In some cases, the carbonate precipitation reactor comprises a CO₂ sequestering device, such as an air contactor. Any suitable air contactor may be employed. In some instances the air contactor is a DAC system, such as a hydroxide based DAC system. DAC systems include, but are not limited to, those described in PCT published application Nos. WO/2009/155539; WO/2010/022339; WO/2013/036859; and WO/2013/120024. In select cases, the air contactor operates by bubbling gas directly through the precipitation reactor solution using a disseminator or other suitable system to produce gas bubbles.

As discussed above, the carbonate precipitation reactor is in a precipitate receiving relationship with a calciner. By “precipitate receiving relationship” it is meant that the carbonate precipitation reactor is operably connected to the calciner in such a manner that PCC produced in the carbonate precipitation reactor—and optionally subjected to further processing—is provided to a calciner configured to produce lime from the PCC. In some embodiments, systems include one or more devices for further processing of the PCC before is received in the calciner. For example, in some embodiments, systems include a thickener configured to reduce the liquid content of the PCC composition. In additional embodiments, systems include a separator configured to carry out a separation process for removing water and/or sulfate from the PCC prior to calcination. In select cases, systems include a filter press. As discussed above, filter presses operate by injecting a slurry into one or more chambers. Pressure in the chambers is increased, and liquid is strained through a filter (e.g., using pressurized air or water). The type of filter press may vary. Examples include plate and frame filter presses, automatic filter presses, recessed plate filter presses, and membrane filter presses. Where aqueous sulfate is separated from the PCC composition, the aqueous sulfate may in some versions be returned to the electrolysis step.

Any convenient calciner may be employed in a precipitate receiving relationship with the carbonate precipitation reactor. Calciners of interest include rotary kilns, vertical kilns, flash kilns, and tunnel kilns. In some instances, calciners subject the PCC to a rotary calcination process. For example, systems may include a rotary vessel (e.g., rotary calciner or rotary kiln). In certain embodiments, the calciners are rotating inclined rotary vessels. Rotation speeds of the rotary vessel may vary, and can range in some embodiments from 10 revolutions per hour to 500 revolutions per hour, such as 15 revolutions per hour to 400 revolutions per hour, such as 20 revolutions per hour to 350 revolutions per hour, such as 25 revolutions per hour to 300 revolutions per hour, such as 30 revolutions per hour to 250 revolutions per hour, and including 35 revolutions per hour to 200 revolutions per hour. In some cases where the rotary vessel is inclined, the incline ranges from 0° to 180°, such as 0° to 45°, and such as 0° to 10°, and including 1° to 4°. The calciner may operate at any temperature suitable for the calcination of PCC. In select cases, the calciner is configured to operate at a temperature ranging from 500° C. to 12,000° C., such as 900° C. to 1,050° C. In select cases, systems are configured to combust a material in order to generate the heat for calcination. In such cases, the requisite temperatures may be achieved by burning fuel such as gas, fuel oil, powdered coal, coke or the like, singularly or in combinations in the gaseous atmosphere of the kiln, with the gases moving countercurrent to the solids through the kiln.

Aspects of the invention also include an electrolyzer. Any suitable electrolyzer configured to electrolyze an aqueous sulfate solution may be employed. In some embodiments, the electrolyzer includes an electrolyzer stack of one or more electrochemical cells comprising an anode within an anode chamber containing an anolyte, a cathode within a cathode chamber containing a catholyte, and an anion exchange membrane separating the anode and cathode chambers. In some such embodiments, the carbonate precipitation reactor is configured to receive a hydroxide solution from the cathode chamber, to generate mineralized carbonate from a sulfate feedstock and CO₂, and to return a portion of the reactor solution to the catholyte.

In some embodiments, the electrochemical cell stack comprises a stack of cells containing an acid-resistant anode (e.g., consisting of titanium, platinized titanium, carbon, or other conductive support) with catalyst for water oxidation (e.g., platinum, iridium oxide, or other catalyst suitable for water oxidation) either deposited on the anode or directly on the membrane and a cathode (e.g., consisting of porous titanium, stainless steel, nickel or other material suitable for water reduction) separated by the membrane, connected to a source of electrical current such as a power supply or potentiostat. In certain cases, on the anode side of the system, the system is configured to flow or recirculate a neutral or acidic aqueous solution (pH<7) consisting of water, sulfuric acid solution, or aqueous salt solution through the anode chamber to allow for the accumulation of sulfuric acid.

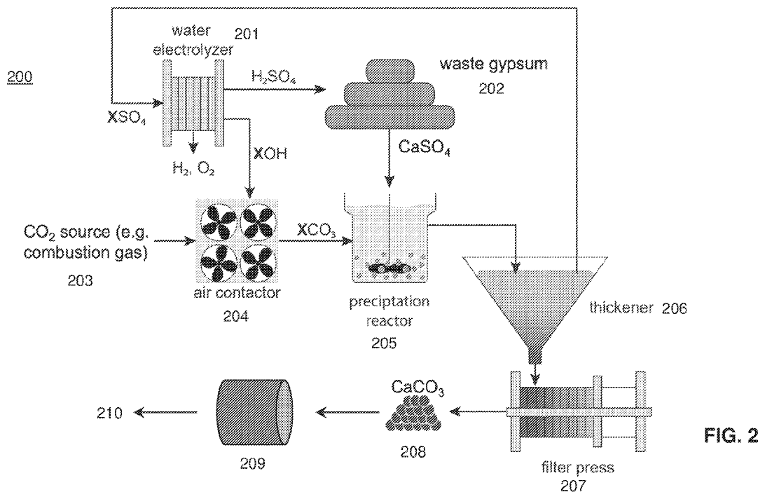

FIG. 2 presents a system of the invention according to certain embodiments. System 200 includes an electrolyzer 201 configured to receive an aqueous sulfate, and produce sulfuric acid (H₂SO₄), oxygen (O₂), hydrogen (H₂) and a base (XOH; where X is a suitable counterion). The hydrogen may be collected for future use. For example, the hydrogen could be used in a hydrogen fuel cell. Oxygen may be vented to the atmosphere, or likewise collected for use in any suitable application. The sulfuric acid may be used, e.g., for fertilizer production, producing waste gypsum 202. System 200 also includes a carbonate precipitation reactor comprising an air contactor 204 and a precipitation reactor 205. The air contactor is a hydroxide based DAC system employing the base (XOH; where X is a suitable counterion) produced from the electrolyzer 201 to produce an aqueous carbonate (XCO₃; where X is a suitable counterion). The precipitation reactor 205 in system 200 employs the aqueous carbonate, and waste gypsum 202 (i.e., phosphogypsum) to produce PCC. The precipitation reactor 205 of the carbonate precipitation reactor is in a precipitate receiving relationship with calciner 209. Before the PCC is received in the calciner 209, it is subjected to further processing in thickener 206 and filter press 207 to produce a PCC product 208. Calciner 209 is configured to convert the PCC product 208 to lime 210, which lime may then be used in the generation of a hydraulic cement.

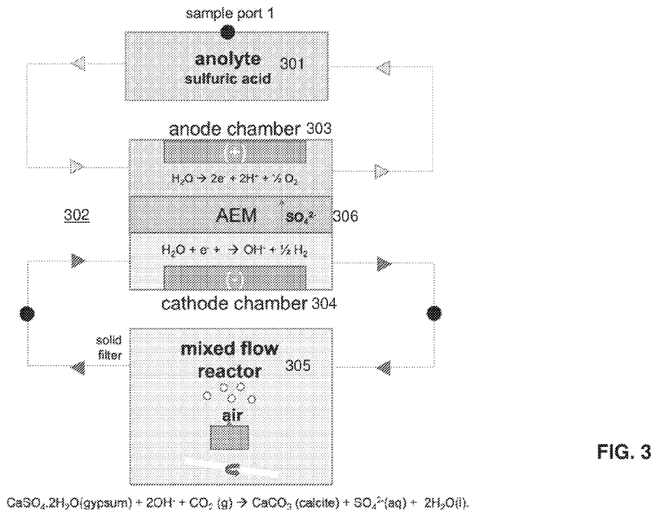

FIG. 3 presents an embodiment of the system focusing on the electrolyzer discussed above. As shown in FIG. 3, calcium sulfate is introduced to a reactor where it is converted to calcium carbonate by reaction with carbon dioxide from air and alkalinity produced in a two-chamber water electrolyzer 302 including an anode chamber 303 and cathode chamber 304. Anolyte 301 is circulated through anode chamber 303. Effluent from precipitation is recirculated through the cathode chamber 304 of the water electrolyzer 302, where sulfate crosses an anion exchange membrane 306 to gradually accumulate sulfuric acid in a recirculating anolyte solution. During operation of the system, sulfuric acid and calcium carbonate are produced by reacting a calcium sulfate source with electrochemically produced hydroxide contacted with carbon dioxide derived from atmospheric air, although more concentrated sources of carbon dioxide can also be used. Sulfuric acid in anolyte 301 is produced and optionally recirculated in the anode chamber 303, and a hydroxide solution is produced from a sulfate feed solution in the cathode chamber 304. Alkaline solutions produced in the cathode chamber 304 are flowed to the reactor 305 where calcium sulfate is reacted with CO₂ from air or another concentrated source and alkalinity to produce solid calcium carbonate products. Sulfuric acid is recovered and optionally concentrated, and produced green hydrogen gas is recovered and optionally either concentrated or used in a fuel cell to generate electricity. Calcium sulfate is introduced to the reactor 305 from phosphoric acid production process. The production of phosphoric acid is accomplished by reacting produced sulfuric acid with phosphate rock, which produces solid calcium sulfate (as phosphogypsum). The waste phosphogypsum produced in is introduced to the mineral precipitation reactor 305, which allows for recycling of the sulfuric acid in phosphoric acid production and importantly avoids the accumulation of phosphogypsum waste.

Additional details regarding aspects of the invention are also found in: U.S. Pat. Nos. 9,714,406; 10,711,236; 10,203,434; 9,707,513; 10,287,439; 9,993,799; 10,197,747; and 10,322,371; as well as published PCT Application Publication Nos. WO 2020/047243 and WO 2020/154518; the disclosures of which are herein incorporated by reference; as well as U.S. Pat. Nos. 8,333,944; 8,177,909; 8,137,455; 8,114,214; 8,062,418; 8,006,446; 7,939,336; 7,931,809; 7,922,809; 7,914,685; 7,906,028; 7,887,694; 7,829,053; 7,815,880; 7,771,684; 7,753,618; 7,749,476; 7,744,761; and 7,735,274; the disclosures of which are herein incorporated by reference.

### Utility

Methods, systems, cements, concretes and built structures of the invention may be employed where it is desirable to achieve economic, environmental, and strategic co-benefits compared to conventional cement production (e.g., Portland cement production), making it suitable for rapid large-scale adoption. In particular, the invention may be employed to generate low-cost, low-carbon cements that are functionally identical to existing cements and require no new capital infrastructure for cement production. The invention may additionally find use in the elimination of phosphogypsum waste during fertilizer production. Such may potentially enable the permitting of new, environmentally responsible phosphorous-based fertilizer plants. Such may be especially of interest in regions that are or are becoming reliant on imported phosphorous fertilizer, which poses a risk to the agricultural sector. Furthermore, as discussed above, phosphogypsum often includes radionuclides posing an environmental risk. Converting phosphogypsum to cement and eventually concrete via the methods and systems of the invention could reduce the risk of ecological and human exposure. In addition, aspects of the invention may be employed where it is desirable to produce saleable green hydrogen.

The following example(s) is/are offered by way of illustration and not by way of limitation.

### EXAMPLES

The following examples are put forth so as to provide those of ordinary skill in the art with a complete disclosure and description of how to make and use the present invention, and are not intended to limit the scope of what the inventors regard as their invention nor are they intended to represent that the experiments below are all or the only experiments performed. Efforts have been made to ensure accuracy with respect to numbers used (e.g., amounts, temperature, etc.) but some experimental errors and deviations should be accounted for. Unless indicated otherwise, parts are parts by weight, molecular weight is weight average molecular weight, temperature is in degrees Centigrade, and pressure is at or near atmospheric.

### Example 1: Phosphogypsum Upcycling for Low-Carbon Hydraulic Cement and Sustainable Fertilizer

### A. Technology Summary

Travertine's electrochemical process (e.g., as described in pending PCT patent application serial no. PCT/US2022/039829 filed on Aug. 9, 2022, the disclosure of which is herein incorporated by reference) drives a replacement reaction that converts waste sulfate salts to precipitated carbonate minerals in reaction with CO₂. For the sulfate source gypsum, the process simultaneously produces sulfuric acid, green hydrogen, and carbon-negative precipitated calcium carbonate (PCC) for use in low-carbon OPC production instead of natural ground calcium carbonate (GCC). The overall reaction to produce PCC can be written:

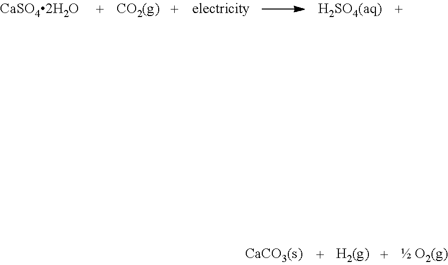

The net CO₂ emissions reduction attributable to using carbon-negative PCC as an OPC feedstock for liming is 60+% and falls within current ASTM standards. Carbon emissions can be further abated by using PCC additives in place of GCC.

Steps of the process can be described as follows (FIG. 1):
1. Sulfuric acid (˜1 M), base (e.g. aqueous NaOH+Ca(OH)₂), green hydrogen, and oxygen are produced by water electrolysis in aqueous sulfate solution.
2. Produced acid is concentrated and used for fertilizer production, generating phosphogypsum.
3. Base produced in the electrolyzer is reacted with carbon dioxide from air or point sources to form aqueous carbonate solution.
4. Reaction of carbonate solution with phosphogypsum produces precipitated calcium carbonate and releases sulfate to solution.
5. Aqueous sulfate is recycled back to the electrolyzer.
   Precipitated calcium carbonate is used in conventional OPC production by liming.

### B. Further Details

The proposed process for phosphogypsum conversion to sulfuric acid and PCC has been demonstrated at the bench scale using pure gypsum. Proof-of-concept tests show that the process can produce sulfuric acid and alkalinity for carbonation at an efficiency approaching the industry-leading chlor-alkali process in several different feedstocks including calcium, sodium, and magnesium sulfate and demonstrate conversion of gypsum to precipitated calcium carbonate. Based on these laboratory results, a techno-economic analysis has been developed which demonstrates that the process is economically viable, including the additional energy required for acid concentration.

The approach described here meets objectives of reducing CO₂ emissions of hydraulic cement production by replacing conventional limestone with a carbon-dioxide negative precipitated calcium carbonate feedstock. Replacing GCC with carbon-negative PCC for liming yields a CO₂ emissions reduction >60% and falls within current ASTM standards, scalable to millions of tons per year, while at the same time eliminating a waste stream that is costly and increasingly difficult for fertilizer producers to permit and manage. The process also eliminates the need for conventional sulfuric acid production by sulfur oxidation, which improves the environmental sustainability of phosphorus fertilizer production and reduces the risk of sulfuric acid shortages currently predicted for mid-century (see, e.g., Maslin et al. The Geographical Journal, 188(4), 498-505). The combined commercial viability, technical feasibility, and multiple environmental co-benefits make the process attractive for large-scale implementation.

### C. Technological Innovation

The methods and systems described here solve two key problems in carbon negative electrochemical PCC production and industrial cement decarbonization:
(1) Commercial implementation of phosphogypsum upcycling for carbon dioxide negative PCC production requires efficient electrolytic acid production coupled with electrolyzer component durability (Monat et al. ACS Sustainable Chemistry & Engineering, 8(6), 2490-2497). Producing concentrated acid requires the use of anion exchange membranes (AEMs), and these tend to rapidly degrade in concentrated strong base. Travertine's technological approach extends the lifetime of AEMs by integrating electrolysis with PCC production, ensuring the membrane contacts dilute base.
(2) Production of ASTM certified hydraulic cements can tolerate only small deviations from the conventional OPC process. This process replaces conventional crushed limestone with a carbon-negative PCC raw feed, enabling low-carbon cement production using existing capital infrastructure. The use of PCC further reduces energy consumption in cement production by eliminating the comminution energy required to crush limestone.

### D. Pilot Plant

A first-of-its-kind plant for carbon negative PCC production and sulfuric acid upcycling that produces ˜2 metric tonnes (T)/day precipitated calcium carbonate for use in OPC production was modeled. The modeled pilot plant was a scale up an existing kg/day system to a 1 T/day pilot. Performance criteria were established for the system to generate overall positive rates of return on capital investment (e.g., IRR>12%) as modeled through a techno-economic analysis that includes both capital investment and operational costs. Assumptions in the model included renewable electricity price of $60/MWh, green hydrogen sales price of $5,000/metric ton (or $2,000/T sales price with a tax credit of $3,000/T; Inflation Reduction Act, 2022), a sulfuric acid sales price of $200/T, and a precipitated calcium carbonate sales price of $50/T based on an evaluation of the relevant markets. The operating point of the system included performance criteria for the electrolyzer, which makes the largest contribution to system operational cost, as well as criteria for the balance of process:

| | unit | value |
|---|---|---|
| Electrolyzer performance criteria | | |
| Energy intensity of acid production achieved | kWh/mol | ≤0.5 |
| | H₂SO₄ | |
| Current density achieved | mA/cm² | ≥150 |
| Acid concentration achieved | M | ≥1 |
| Base concentration achieved | M | >0.03 |
| Hydrogen recovery | % | ≥95 |
| Balance of process performance criteria | | |
| Precipitation residence time achieved | min. | ≤100 |
| % CO₂ removal from combustion gas achieved | % | ≥75 |
| % conversion gypsum to carbonate | % | >80 |
| PCC purity | % | >95 |

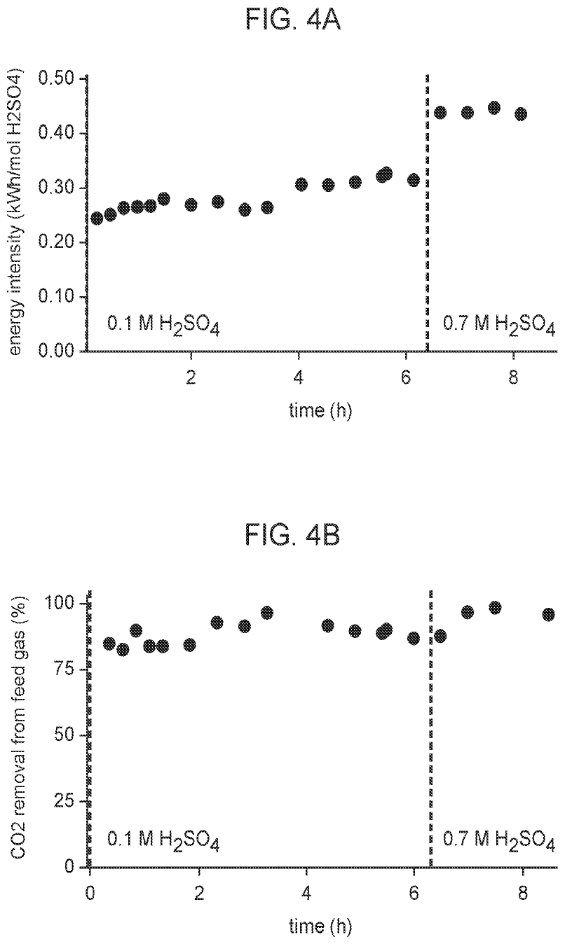

The modeling work demonstrated that the electrolyzer target operating point is achievable under conditions relevant to the full process. FIG. 4A-B illustrate the process performance in a bench-top system test using 0.1M and 0.7M H₂SO₄ feed solutions to mimic a range of anolyte compositions.

### E. Technology Comparison to the State-of-the-Art & Technology Impact

The methods and systems described herein provide several complementary economic, environmental, and strategic co-benefits compared to state-of-the-art Portland cement production, making them suitable for rapid large-scale adoption.
1. The disclosed process produces low-cost, low-carbon cements that are functionally identical to existing cements and require no new capital infrastructure for cement production.
2. The disclosed process eliminates phosphogypsum waste during P fertilizer production, enabling the permitting of new, environmentally responsible P fertilizer plants in the United States. As legacy plants phase out, the US will become reliant on imported P fertilizer, which poses a strategic risk to the agricultural sector.
3. Converting PG to cement and eventually concrete reduces the risk of ecological and human exposure to radionuclides associated with PG.
4. The process generates saleable green hydrogen that is eligible for a $3/kg tax credit offered in the Inflation Reduction Act.

In the near term, the disclosed PCC process maintains business-as-usual cement plant operation, while other electrochemical technologies require modification of calciners for portlandite liming, and also fail to remove process-based CO₂. The disclosed process can be combined with electrochemical calcination as cement manufacturing infrastructure reaches its useful lifespan.

TABLE 1
Comparison of the proposed concept to conventional
OPC with respect to program technological targets.

| | LCA net GHG | Change in land | Waste reuse/ |
|---|---|---|---|
| Technology | emissions | footprint | recycling |
| This Concept | Net emissions | Decrease due to | PG waste |
| | reduced | reduced limestone | valorization and |
| | by >60% | mining & PG | acid recycling |
| | | brownfield | |
| | | reclamation | |
| Conventional | Net emissions | Limestone mining | Limited (e.g. minor |
| OPC | (~0.9 ton | required | municipal solid |
| | CO2e/ton) | | waste, calcium |
| | | | silicate waste, etc.) |

Notwithstanding the appended claims, the disclosure is also defined by the following clauses:
1. A method of making a hydraulic cement, the method comprising employing precipitated calcium carbonate (PCC) as a feedstock for lime (CaO) production.
2. The method according to Clause 1, wherein the method comprises calcining the PCC to produce the lime.
3. The method according to Clause 1 or 2, wherein the method further comprises employing the lime in the production of a clinker.
4. The method according to any of the preceding clauses, wherein the PCC is a carbon negative PCC.
5. The method according to Clause 4, wherein the carbon negative PCC is produced by a CO₂ sequestering protocol.
6. The method according to Clause 5, wherein the CO₂ sequestering protocol comprises direct air capture (DAC).
7. The method according to Clause 5 or 6, wherein the CO₂ sequestering protocol employs gypsum (CaSO₄·2H₂O) as a feedstock.
8. The method according to Clause 7, wherein the gypsum comprises phosphogypsum.
9. The method according to any of the preceding clauses, wherein the PCC is produced by an electrolytic protocol.
10. The method according to Clause 9, wherein the electrolytic protocol comprises the use of an anion exchange membrane separating an anode chamber comprising an anolyte and a cathode chamber comprising a catholyte.
11. The method according to Clause 10, wherein the anion exchange membrane is configured so that sulfate anion crosses the anion exchange membrane to the anode chamber where sulfuric acid is generated.
12. The method according to Clause 11, further comprising maintaining a concentration of base in the catholyte that is low relative to the concentration of acid in the anolyte.
13. The method according to Clause 12, wherein the method comprises recirculating fluid through the cathode chamber.
14. The method according to any of the preceding clauses, wherein the PCC is produced by a reaction that may be written as:

CaSO₄·2H₂O+CO₂(g)+electricity→H₂SO₄(aq)+CaCO₃(s)+H₂(g)+½O₂(g).
15. The method according to Clause 14, further comprising employing the sulfuric acid (H₂SO₄) in hydrometallurgical extraction or recovery.
16. The method according to Clause 15, wherein the hydrometallurgical extraction or recovery comprises sulfuric acid leaching of lithium claystone or a magnesium silicate.
17. The method according to any of the preceding clauses, wherein the hydraulic cement comprises an ordinary Portland cement (OPC).
18. The method according to any of the preceding clauses, further comprising producing a concrete from the cement.
19. The method according to any of the preceding clauses, further comprising slaking the lime to produce calcium hydroxide (Ca(OH)₂).
20. A hydraulic cement prepared according to any of Clauses 1 to 17.
21. A concrete prepared according to the method of Clause 18.
22. A built structure produced from a hydraulic cement according to Clause 20 or a concrete according to Clause 21.
23. A system comprising:
   a carbonate precipitation reactor configured to produce precipitated calcium carbonate (PCC); and
   a calciner in a precipitate-receiving relationship with the carbonate precipitation reactor.
24. The system according to Clause 23, wherein the calciner is a rotary calciner.
25. The system according to Clause 23 or 24, further comprising an electrolyzer stack of one or more electrochemical cells comprising:
   an anode within an anode chamber containing an anolyte,
   a cathode within a cathode chamber containing a catholyte, and
   an anion exchange membrane separating the anode and cathode chambers.
26. The system according to Clause 25, wherein the carbonate precipitation reactor is configured to receive a hydroxide solution from the cathode chamber, to generate mineralized carbonate from a sulfate feedstock and CO₂, and to return some or all of the reactor solution to the cathode chamber.
27. The system according to Clause 26, further comprising a sulfuric acid recovery module configured to receive sulfuric acid from the anode chamber.
28. The system according to any of Clauses 23 to 27, wherein the system is configured as a continuous flow system.
29. The system according to any of Clauses 23 to 28, wherein the carbonate precipitation reactor is operably connected to a source of sulfate.
30. The system according to Clause 29, wherein the source of sulfate comprises calcium sulfate.
31. The system according to any of Clauses 23 to 30, wherein the carbonate precipitation reactor is operably connected to a source of CO₂.
32. The system according to Clause 31, wherein the source of CO₂ comprises air.
33. The system according to Clause 31, wherein the source of CO₂ comprises a flue gas.
34. The system according to Clause 26, wherein the anion exchange membrane is configured so that sulfate anion crosses the anion exchange membrane to the anode chamber where sulfuric acid is generated.
35. The system according to Clause 34, wherein the system is configured to maintain a concentration of base in the catholyte that is low relative to the concentration of acid in the anolyte.
36. The system according to Clause 35, wherein the system is configured to recirculate fluid from the carbonate precipitation reactor through the cathode chamber.

In at least some of the previously described embodiments, one or more elements used in an embodiment can interchangeably be used in another embodiment unless such a replacement is not technically feasible. It will be appreciated by those skilled in the art that various other omissions, additions and modifications may be made to the methods and structures described above without departing from the scope of the claimed subject matter. All such modifications and changes are intended to fall within the scope of the subject matter, as defined by the appended claims.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible sub-ranges and combinations of sub-ranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into sub-ranges as discussed above. Finally, as will be understood by one skilled in the art, a range includes each individual member. Thus, for example, a group having 1-3 articles refers to groups having 1, 2, or 3 articles. Similarly, a group having 1-5 articles refers to groups having 1, 2, 3, 4, or 5 articles, and so forth.

Although the foregoing invention has been described in some detail by way of illustration and example for purposes of clarity of understanding, it is readily apparent to those of ordinary skill in the art in light of the teachings of this invention that certain changes and modifications may be made thereto without departing from the spirit or scope of the appended claims.

Accordingly, the preceding merely illustrates the principles of the invention. It will be appreciated that those skilled in the art will be able to devise various arrangements which, although not explicitly described or shown herein, embody the principles of the invention and are included within its spirit and scope. Furthermore, all examples and conditional language recited herein are principally intended to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. Moreover, nothing disclosed herein is intended to be dedicated to the public regardless of whether such disclosure is explicitly recited in the claims.

The scope of the present invention, therefore, is not intended to be limited to the exemplary embodiments shown and described herein. Rather, the scope and spirit of present invention is embodied by the appended claims. In the claims, 35 U.S.C. § 112(f) or 35 U.S.C. § 112(6) is expressly defined as being invoked for a limitation in the claim only when the exact phrase “means for” or the exact phrase “step for” is recited at the beginning of such limitation in the claim; if such exact phrase is not used in a limitation in the claim, then 35 U.S.C. § 112 (f) or 35 U.S.C. § 112(6) is not invoked.

1. A method of making a hydraulic cement, the method comprising employing precipitated calcium carbonate (PCC) as a feedstock for lime (CaO) production.

2. The method according to claim 1, wherein the method comprises calcining the PCC to produce the lime.

3. The method according to claim 1, wherein the method further comprises employing the lime in the production of a clinker.

4. The method according to claim 1, wherein the PCC is a carbon negative PCC.

5. The method according to claim 4, wherein the carbon negative PCC is produced by a CO₂ sequestering protocol.

6. The method according to claim 5, wherein the CO₂ sequestering protocol comprises direct air capture (DAC).

7. The method according to claim 5, wherein the CO₂ sequestering protocol employs gypsum (CaSO₄·2H₂O) as a feedstock.

8. The method according to claim 7, wherein the gypsum comprises phosphogypsum.

9. The method according to claim 1, wherein the PCC is produced by an electrolytic protocol.

10. The method according to claim 9, wherein the electrolytic protocol comprises the use of an anion exchange membrane separating an anode chamber comprising an anolyte and a cathode chamber comprising a catholyte.

11. The method according to claim 10, wherein the anion exchange membrane is configured so that sulfate anion crosses the anion exchange membrane to the anode chamber where sulfuric acid is generated.

12. The method according to claim 11, further comprising maintaining a concentration of base in the catholyte that is low relative to the concentration of acid in the anolyte.

13. The method according to claim 12, wherein the method comprises recirculating fluid through the cathode chamber.

14. A hydraulic cement prepared according to claim 1, or a built structure produced therefrom.

15. A system comprising:
a carbonate precipitation reactor configured to produce precipitated calcium carbonate (PCC); and
a calciner in a precipitate-receiving relationship with the carbonate precipitation reactor.
